(19) United States
(12) Patent Application Publication
(10) Pub. No.: US 2024/0227142 A9
(43) Pub. Date: Jul. 11, 2024

(54) EXTENSION TOOL TO HANG ATTACHMENTS IN EXTERIOR SPACES

(71) Applicant: Terry Nelson, Willard, UT (US)

(72) Inventor: Terry Nelson, Willard, UT (US)

(21) Appl. No.: 17/970,025

(22) Filed: Oct. 20, 2022

(51) Int. Cl. B25B 31/00

(52) U.S. Cl. CPC B25B 31/00

(57) ABSTRACT

A method includes placing a tube at an initial position. The method also includes positioning one or more clips into the tube. The method further includes placing one or more attachments onto the one or more clips. The method also includes identifying one or more areas to move the one or more clips with the one or more attachments. The method also includes placing the one or more clips with the one or more attachments onto the one or more identified areas.

### TECHNICAL FIELD

The present disclosure generally relates to an extension apparatus to hanging ornaments or lights or other attachments in difficult-to-reach places.

### BACKGROUND

Current methods to hang lights or decorations in hard to reach areas come with various risks. A user often has to use a step device or ladder to manually climb to the desired location. Such a location can often be at a high distance from the ground.

As the user is manually climbing the distance, the user often has to ensure that no fall occurs. The process of climbing a ladder or even a step device can be cumbersome. Should the user accidentally fall, the user can suffer severe injuries as a result.

Another disadvantage is that it can take a user a considerable amount of time to manually climb a device. Further, it can also take the user a considerable amount of time after climbing a device to manually hang or place the times in the desired locations.

Accordingly, a device is needed that will reduce the risk that is involved to users. The device should ensure that the user does not entail harm of any kind while trying to hang or place items at the top of a home or building or tree.

In addition, a device should also reduce the time and make it easier and more efficient for the user to hang items such as lights or decorations. The device should make it safe and efficient for the user to be able timely place desired items such as lights and other decorations into normally hard to reach areas.

### SUMMARY

The following summary is provided to facilitate an understanding of some of the features of the disclosed embodiments and is not intended to be a full description. A full appreciation of the various aspects of the embodiments disclosed herein can be gained by taking the specification, claims, drawings, and abstract as a whole.

The aforementioned aspects and other objectives can now be achieved as described herein.

In an embodiment, a method includes placing a tube at an initial position. The method also includes positioning one or more clips into the tube. Further, the method includes placing one or more attachments onto the one or more clips. In addition, the method also includes identifying one or more areas to move the one or more clips with the one or more attachments. The method also includes placing the one or more clips with the one or more attachments onto the one or more identified areas.

The method also includes pushing the tube onto the one or more clips to release the one or more attachments onto the one or more identified areas.

The one or more identified areas is a top portion of a home.

In an embodiment, a method includes identifying a tube at an initial position. The method also includes placing at least one clip within the tube. The at least one clip will include a v-shape. The at least one clip will be configured to be moved in a vertical direction. The at least one clip will e configured to be attached to at least one decoration or other attachment and configured to be moved with the at least one decoration or other attachment. The method also include identifying a final position to place the at least one clip with the at least one decoration or other attachment.

The method also includes positioning the at least one clip with the at least one decoration or other attachment onto the final position.

The method also includes placing an additional decoration into the at least one clip

In an embodiment, a system includes an installation tool configured onto an extension pole. The system also includes a tube placed at an initial position next to the extension pole. Further, the system includes one or more clips positioned into the tube. The system also includes one or more attachments placed onto the one or more clips. In addition, the system includes one or more areas to position the one or more clips with the one or more attachments, wherein the one or more clips with the one or more attachments are placed onto the one or more identified areas.

The one or more areas include a top portion of a home or a tree.

The one or more clips include at least one v-shaped clip.

### BRIEF DESCRIPTION OF THE FIGURES

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1(A) illustrates components of a device in accordance with an embodiment of the invention;

FIG. 1(B) shows a further illustrating of the device in accordance with an embodiment of the invention;

FIG. 2 illustrates clips in accordance with the invention;

FIG. 3 illustrates applications of the clips in accordance with the invention;

FIG. 4 illustrates the clips and the device being placed together according to an embodiment of the invention.

FIG. 5 shows a clip removal tool in accordance with an embodiment of the invention.

FIG. 6 depicts a flowchart in accordance with an embodiment of the invention

Unless otherwise indicated illustrations in the figures are not necessarily drawn to scale.

### DETAILED DESCRIPTION OF SOME EMBODIMENTS

### Background and Context

The particular values and configurations discussed in these non-limiting examples can be varied and are cited merely to illustrate one or more embodiments and are not intended to limit the scope thereof.

Subject matter will now be described more fully herein after with reference to the accompanying drawings, which form a part hereof, and which show, by way of illustration, specific example embodiments. Subject matter may, however, be embodied in a variety of different form and, therefore, covered or claimed subject matter is intended to be construed as not being limited to any example embodiments set forth herein, example embodiments are provided merely to be illustrative. Likewise, a reasonably broad scope for claimed or covered subject matter is intended. Among other issues, subject matter may be embodied as methods, devices, components, or systems. The followed detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein may not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Generally, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as a “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

One having ordinary skill in the relevant art will readily recognize the subject matter disclosed herein can be practiced without one or more of the specific details or with other methods. In other instances, well-known structures or operations are not shown in detail to avoid obscuring certain aspects. This disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

Unless defined otherwise, all technical and scientific terms used herein have the same meanings as commonly understood by one of ordinary skill in the art to which the disclosed embodiments belong. Preferred methods, techniques, devices, and materials are described, although any methods, techniques, devices, or materials similar or equivalent to those described herein may be used in the practice or testing of the present invention.

Although claims have been included in this application to specific enumerated combinations of features, it should be understood the scope of the present disclosure also includes any novel feature or any novel combination of features disclosed herein.

References “an embodiment,” “example embodiment,” “various embodiments,” “some embodiments,” etc., may indicate that the embodiment(s) so described may include a particular feature, structure, or characteristic, but not every possible embodiment necessarily includes that particular feature, structure, or characteristic.

Headings provided are for convenience and are not to be taken as limiting the present disclosure in any way.

Each term utilized herein is to be given its broadest interpretation given the context in which that term is utilized.

### Terminology

The following paragraphs provide context for terms found in the present disclosure (including the claims):

The transitional term “comprising”, which is synonymous with “including,” “containing,” or “characterized by,” is inclusive or open-ended and does not exclude additional, unrecited elements or method steps. See, e.g., Mars Inc. v. H.J. Heinz Co., 377 F.3d 1369, 1376, 71 USPQ2d 1837, 1843 (Fed. Cir. 2004) (“Nike the term ‘comprising,’ the terms ‘containing’ and ‘mixture’ are open-ended.”). “Configured to” or “operable for” is used to connote structure by indicating that the mechanisms/units/components include structure that performs the task or tasks during operation. “Configured to” may include adapting a manufacturing process to fabricate components that are adapted to implement or perform one or more tasks.

“Based On.” As used herein, this term is used to describe factors that affect a determination without otherwise precluding other or additional factors that may affect that determination. More particularly, such a determination may be solely “based on” those factors or based, at least in part, on those factors.

All terms of example language (e.g., including, without limitation, “such as”, “like”, “for example”, “for instance”, “similar to”, etc.) are not exclusive of other examples and therefore mean “by way of example, and not limitation . . . ”.

A description of an embodiment having components in communication with each other does not infer that all enumerated components are needed.

A commercial implementation in accordance with the scope and spirit of the present disclosure may be configured according to the needs of the particular application, whereby any function of the teachings related to any described embodiment of the present invention may be suitably changed by those skilled in the art.

The flowchart and block diagrams in the figures illustrate the architecture, functionality, and operation of possible implementations of systems and methods according to various embodiments. Functions noted in the block may occur out of the order noted in the figures. For example, two blocks shown in succession may, in fact, be executed substantially concurrently, or the blocks may sometimes be executed in the reverse order, depending upon the functionality involved.

Further, any sequence of steps that may be described does not necessarily indicate a condition that the steps be performed in that order. Some steps may be performed simultaneously.

The functionality and/or the features of a particular component may be alternatively embodied by one or more other devices that are not explicitly described as having such functionality/features. Also, various embodiments of the present invention need not include a device itself.

More specifically, as will be appreciated by one skilled in the art, aspects of the present invention may be embodied as a system and/or method. Furthermore, aspects of the present invention may take the form of a plurality of systems to enable gas meter to perform self-checking to determine its overall functioning without requiring a meter operator.

### INTRODUCTION

Embodiments of the present invention include an extension device for placing decorations, lights, and other attachments into hard to reach areas. A user can use the extension device to place the attachments without having to manually use a ladder or step device to place the items. The user can remain on the ground and use the extension device to hang the lights or decorations.

The user will place his desired clip and attachments at the top portion of the extension device. The user can decide the size and shape of the clips to be used. The user can also decide what type of attachments can be used. The user can decide to hang Christmas lights or hang decorations, and place these items onto the clips within the top portion of the extension device.

The user can then identify where the lights/decorations should be positioned. The user can determine that such attachments should be placed at a top portion of the tree. The user can also determine that the top portion of a house should be where the attachments on the clips should be placed. Once the user has identified where the attachments should be placed, the user can extend the extension device manually to the desired location.

When the user has placed the extension device at the desired location, the user can release the clips with the attachments. As a result, Christmas lights at a top portion of the tree can be placed efficiently without the user having to climb to the top portion of the tree and risk falling or sustaining any injuries. Further, the top portion of a home can also receive decorations without the user having to manually climb a ladder and place them by hand.

### System Structure

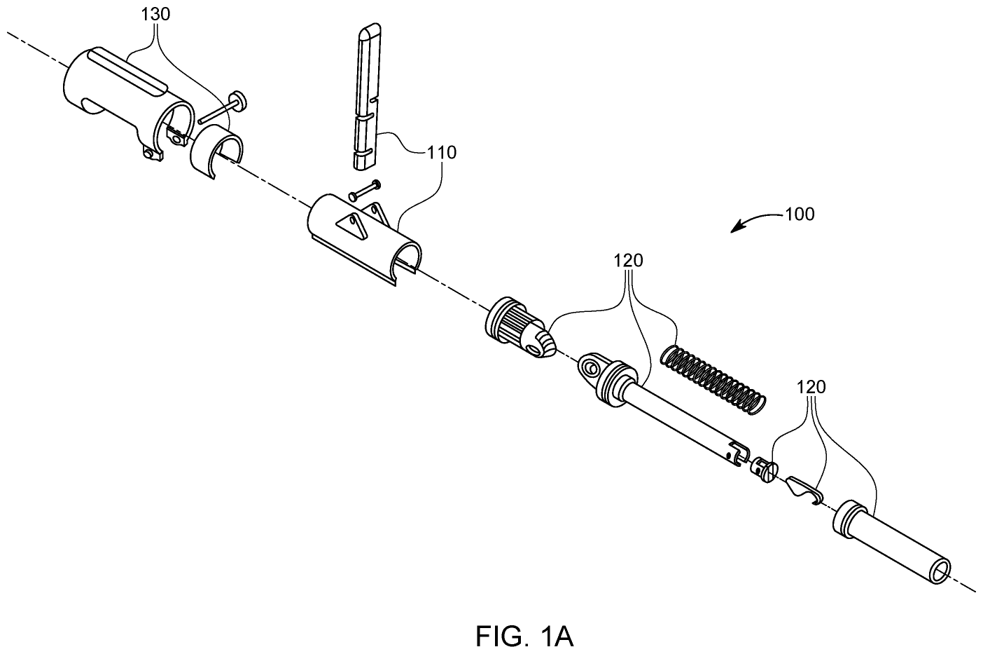

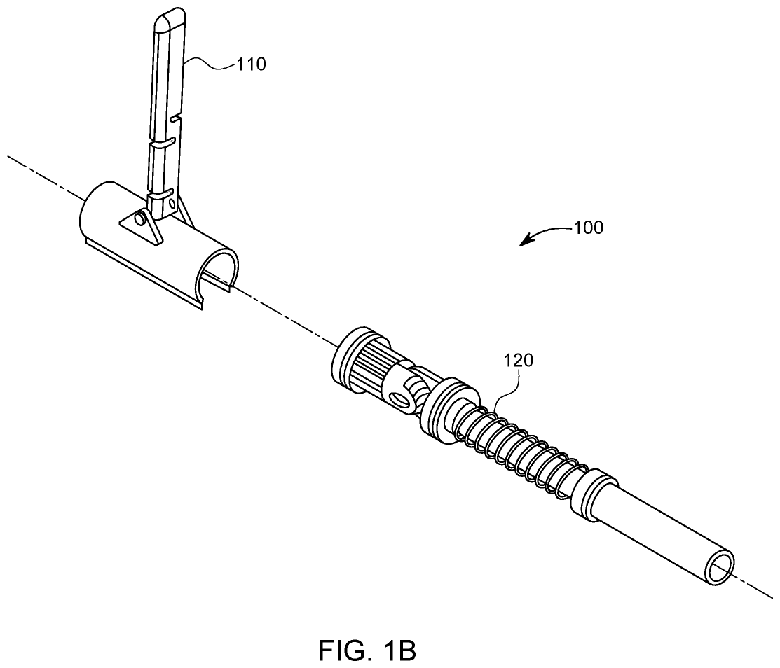

FIGS. 1(A) & 1(B) illustrates device 100 for attaching ornaments and decorations into hard to reach places. The device 100 includes a clip that is placed at an end of the extension device 100. The clip will be used to attach decorations or other attachments. The decorations or other attachments can be lights that can be hung on a tree or at the top of a home. The user may not want to use a ladder to place the attachments or decorations manually. The user may want to use the extension device 100 to place the decorations and attachments. The various components 110, 120, 130 of the extension device 100 are illustrated.

With respect to FIGS. 1(A) and 1(B), clips will be installed at an opening shown in one of the components 120 of the extension device 100. The extension device 100 have a string that enables the extension device 100 to release clips extend in length to a desired area such as the top of a tree or home that may be difficult to reach by a ladder.

Referring to FIGS. 1(A) and 1(B), the extension device 100 will include the various components 110, 120, 130 to enable the clips to be placed at the top of homes and other difficult to reach places. A string can be used in conjunction with the extension device. The string will aid the extension device with its process of placing the clip or clips at the top of a home or a large Christmas tree as examples. The user can move the extension device to the desired area that he/she wishes to hang lights/ornaments or other attachments. Such an area, as mentioned above, can be the top of a tree or home that would be normally difficult for the user to reach. The extension device 100 enables the user to reach this area by extending the component 120 with the attached clip to the identified area. Once the clip with the attachment or decorations as reached the identified area, the user can use a string that is attached to the extension device 100 to then release the decorations/attachments on the desired area. As such, the user does not need to laboriously climb ladder and manually place the decoration to the desired location, Instead, the extension device 100 enables the user to extend the extension device 100 to the desired location and place the decorations at the desired spot or location.

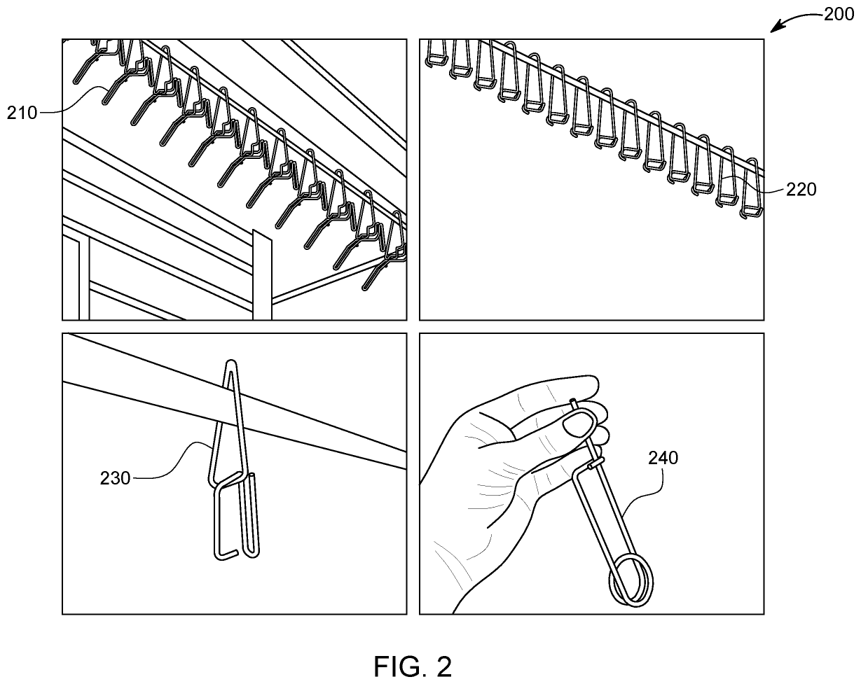

In FIG. 2, a system 200 is shown with various types of clip sizes. The clips 210 can be used to hang one or more decorations at the top portion of a home. A user cannot typically reach the top portion of the home and can attach the decorations or lights onto the clips 210 to hang at the top of the hope. Another set of clips 220 is also shown. The second set of clips 220 can be in a different size or shape than the first set of clips 210. Like the first set of clips 210, these second set of clips 220 can also be used to hang decorations or other attachments at hard to reach places. The different size or shape of the second set of clips 220 can enable the user to use different ornaments or attachments to be positioned at the top of the home as an example.

Referring to FIG. 2, a third set of clips 230 is shown. The third set of clips 230 also come in a different size and shape than the first and second set of clips 210, 220. The third set of clips 230 can be used to hang items within a user's attic that the user cannot reach. The shapes of the third set of clips 230 enable the user to attach the type of items that the user wishes to hang or position within a hard to reach area. Further, within the home, there can be hard to reach places that the user wishes to place items. The third set of clips 230 can enable the user to place those items within the home. A fourth set of clips 240 is also shown. The fourth set of clips 240, similar to the first, second, and third set of clips 210, 220, and 230, can also hang items in hard to reach places either within the home or outside of the home. The unique shape of the fourth set of clips 240 also allows the user to place the specific type of items that the user wishes to place in the hard to reach location.

Referring to FIG. 2, the first set of clips 210, second set of clips 220, third set of clips 230, and fourth set of clips 240 each have their own unique shape. The shapes of the first to fourth set of clips 210, 220, 230, and 240 enable the user(s) to place the desired items within the first to fourth set of clips 210, 220, 230, 240 to position at the hard-to-reach location. The user can any one of these sets of clips 210, 220, 230, 240 with various items to hang the various items that the user normally would not be able to reach. The device in which the user can use to attach these clips is substantially similar to the device shown in FIG. 1.

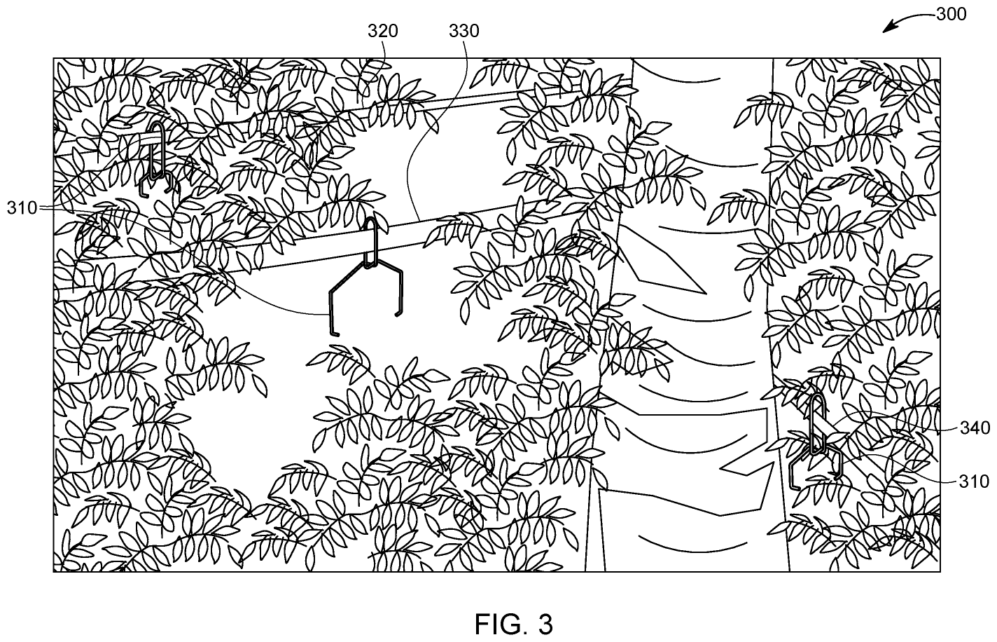

In FIG. 3, a system 300 is illustrated in which a user desires to hang Christmas lights on various difficult to reach portions of a large Christmas tree. The various clips 310 are shown. The various clips 310 will be substantially similar to the clips described in FIG. 2, The clips 310 can be attached onto the extension device by the method described above in FIG. 1. The user can identify one or more locations 320, 330, and 340 within the tree. The user can extend the extension device as needed to the desired location within the Christmas tree. The clip can be attached to the end of the extension device. The portion of the extension device with the clips can be extended to the one or more locations 320, 330, 340. The one or more locations 320, 330, 340 would be difficult or even impossible for a user to reach. Further, should the user desire to use a ladder, the process of easily hanging the lights in the desired locations 320, 330, 340 would be cumbersome and dangerous.

Still referring to FIG. 3, the user can identify the locations 320, 330, 340 before placing the tree clips 310 onto the extension device. After the user has identified the locations 320, 330, 340, the user can then position the right tree clips 310 onto the extension device. The user can use the extension device to extend the end of the extension device with the tree clips 310 to at least one of the locations 320, 330, 340. After the user has positioned the tree clips 310 with the attachments (such as Christmas lights), the user can release the clips 310 onto the location 320 on the tree. The user can attach another set of the tree clips 310 onto the extension device, and then position the tree clips 310 via the extension device onto the next location 330. Further, the user can release the tree clips 310 with the Christmas lights on the next location 330 when the user has reached the next location 330. Similarly, the user can attach another set of tree clips 310 onto the extension device to hang additional lights in the third location 340. The user can extend the extension device with the tree clips 310 to the third location 340. When the user has reached the third location 340, the user can release the tree clips 310 from the extension device to hang the Christmas lights at the third location 340.

With respect to FIG. 3, the tree clips 310 will enable a user to hang Christmas lights in virtually any size tree that would normally be cumbersome for the user to reach by a ladder or other device. The user can use a series of the tree clips 310 to hang various lights in multiple locations within the Christmas tree that the user normally would not be able to reach manually with a traditional ladder.

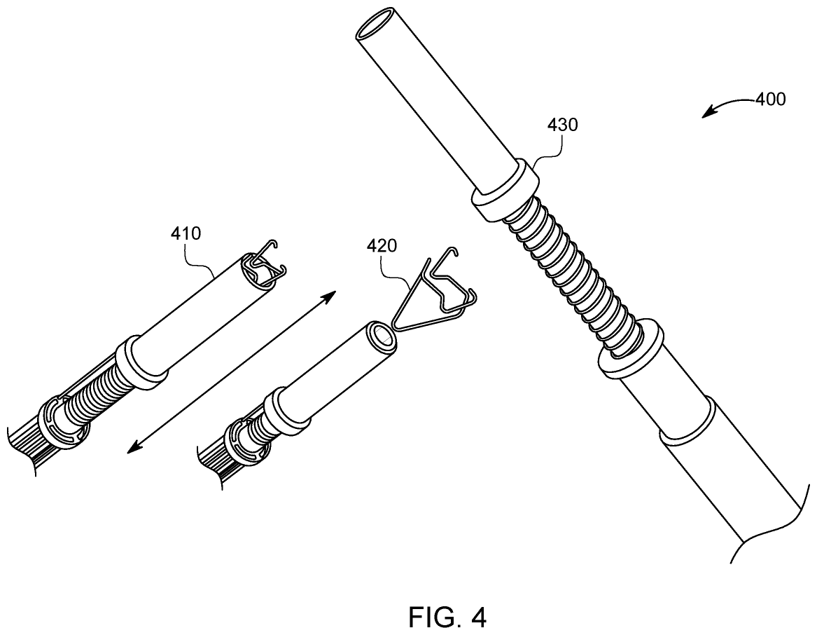

Referring to FIG. 4, the extension device 400 is shown in more detail. The clip installation tool 410 is a spring-based shaft that can hold the clips that are compressed for installation. The clip installation tool 410 can be pressed down to allow the clips to decompress and attach to the desired surface at the top of a home or tree. The spring-based shaft in the clip installation tool 410 is pulled down by a string that is enabled by an installation slider within the installation tool 410. The extension device 400 can also be extended as required to the desired location that is ordinarily difficult to reach otherwise.

In FIG. 4, clips 420 are shown. The clips 420 can be substantially similar to the clips described in FIGS. 2 and 3. The clips 420 will be installed using the installation tool 410 onto the desired location. The user will use the extension device 400 to move the clips 420 to the desired location. As shown above in previously in FIGS. 2 and 3, the extension device 400 will be moved to a location such as a tree or home. Other difficult to reach areas can be the top of a commercial building as well. Once the extension device 400 has reached the top of the tree or house or desired location, the clips 420 can be released onto the desired location. Either a single clip 420 or multiple clips 420 can be used in one or more embodiments. The extension device 400 being able to extend to the desired location eliminates the needs for users to have to use a ladder to reach the hard to reach locations.

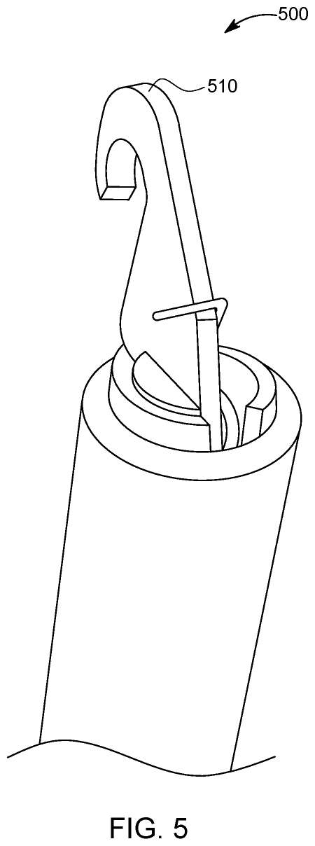

Referring to FIG. 5, a clip removal tool 500 is illustrated with the clip 510, Once the clip 510 has been positioned at the desired location by the extension device, the clip 510 can be removed by the clip removal tool 500. One or more decorations or attachments can be attached to the clip 510. In addition, should the user simply desire to remove the clip 510, the clip removal tool 500 can also be used to remove the clip 510. In either situation, whether it is to remove the clip 510 with decorations, or simply replace the clip 510 or take the clip out of the extension device, the clip removal tool 500 can enable the clip 510 to be easily removed.

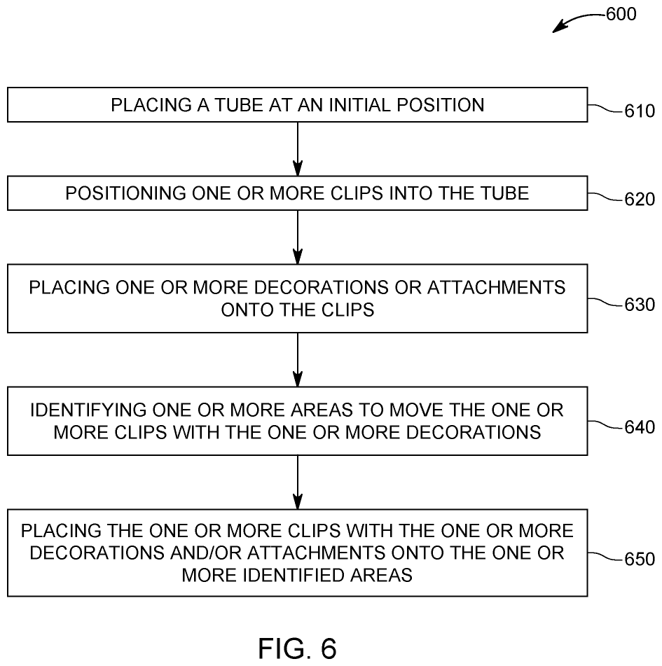

Referring to FIG. 6, a method 600 is illustrated for placing clips with decorations at hard to reach areas. As a result, users do not need to use ladders or other cumbersome devices to hang attachments or ornaments in these hard to reach places.

In FIG. 6, at step 610, a tube within the extension device is positioned at an initial position. The tube will be configured to receive one or more clips that will be used to hang attachments and ornaments.

Referring to FIG. 6, at step 620, one or more clips are placed within the tube of the extension device. The clips will be placed within the extension device to hang attachments such as lights or Christmas decorations. The clips will be used to hang one or more attachments or decorations of the user's preferences.

In FIG. 6, at step 630, one or more attachments or decorations are placed on the clips. The attachments or decorations can be Christmas lights or ornaments. The user can place any attachment that he/she prefers to be placed onto the clips.

Referring to FIG. 6, at step 640, the user will identify one or more areas to move the clips with the one or more decorations. The user can decide to hang lights at the top of his/her home. The user can also decide to hang lights onto a large tree. The user can identify any area of preference to hang the decorations or attachments. The extension device enables the user to hang the attachments or decorations that may be normally hard to reach.

In FIG. 6, at step 650, the clips with the decorations or attachments can be positioned at the one or more identified areas. The user can use the extension device to move the clips to the hard to reach areas. These areas can be the top of a home or tree as examples. Once the extension device with the clips and attachments as reached the identified areas, the user can release the clips with the attachments and decorations. As such, the house or tree will receive the Christmas lights, decorations, or other attachments that the user wanted to place at the identified areas.

### Summary/Advantages

Overall, the extension device provides many advantages for users as opposed to users using steps or ladders. Hard to reach areas at the top of homes and trees are very cumbersome for users to reach and then hang lights or decorations.

The extension device enables users to hang lights or other decorations on various hard to reach areas. The user can attach the desired clip inside of the top portion of the extension device. Within the clips, the user can place lights, decorations, and other attachments. The user can use a string in conjunction with the device where it is needed.

The user can extend the extension device to a top of a home or tree with the attachments at the top of the extension device within the clip that is being used. When the user has reached the desired location, the user can then release the clips with the attachments onto the location. The string that the user is using can assist the user in the various functions of the extension device.

The top portion of the home, tree, or other difficult to reach area has received the lights or ornaments that the user desired to place at that location. The user has not risked any undue risk due to climbing a ladder or step device. The user has been able to place lights and/or ornaments in the hard to reach areas in a safe and efficient manner. The user can simply reuse the extension device for other items that the user desires to place at the hard to reach areas.

### CONCLUSION

All references, including granted patents and patent application publications, referred herein are incorporated herein by reference in their entirety.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Various aspects of the invention have been described above by way of illustration, and the specific embodiments disclosed are not intended to limit the invention to the particular forms disclosed. The particular implementation of the system provided thereof may vary depending upon the particular context or application. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

The corresponding structures, materials, acts, and equivalents of all means or step plus function elements in the claims below are intended to include any structure, material, or act for performing the function in combination with other claimed elements as specifically claimed.

1. A method comprising:
placing a tube at an initial position;
positioning one or more clips into the tube;
placing one or more attachments onto the one or more clips;
identifying one or more areas to move the one or more clips with the one or more attachments; and
placing the one or more clips with the one or more attachments onto the one or more identified areas.

2. The method of claim 1, further comprising:
pushing the tube onto the one or more clips to release the clips onto the one or more identified areas.

3. The method of claim 1, wherein the one or more identified areas is a top portion of a home.

4. The method of claim 1, wherein the one or more decorations or attachments are positioned in an open end of the one or more clips.

5. The method of claim 1, further comprising:
placing an installation tool within an extension pole.

6. The method of claim 1, further comprising:
releasing the one or more clips with the one or more decorations or attachments.

7. The method of claim 1, wherein at least one of the one or more clips includes a v-shape.

8. A method comprising:
identifying a tube at an initial position;
placing at least one clip within the tube, wherein the at least one clip will include a v-shape, and wherein the at least one clip will be configured to be moved in a vertical direction, and wherein the at least one clip will be configured to be attached to at least one decoration or other attachment, and configured to be moved with the at least one decoration or other attachment; and
identifying a final position to place the at least one clip with the at least on decoration or other attachment.

9. The method of claim 8, further comprising:
positioning the at least one clip with the at least one decoration or other attachment onto the final position.

10. The method of claim 8, further comprising:
placing an additional decoration into the at least one clip.

11. The method of claim 8, further comprising:
identifying an additional position after the final position to place the at least one clip with the at least one decoration or other attachment.

12. The method of claim 8, wherein the at least one decoration includes a plurality of lights.

13. The method of claim 8, further comprising:
releasing the clip from a portion of a tree.

14. The method of claim 8, further comprising:
pushing an extension pole toward the at least one clip to pull the at least one clip into the tube.

15. A system comprising:
an installation tool configured onto an extension pole;
a tube placed at an initial position next to the extension pole;
one or more clips positioned into the tube;
one or more attachments placed onto the one or more clips;
one or more areas to position the one or more clips with the one or more attachments, wherein the one or more clips with the one or more attachments are placed onto the one or more identified areas.

16. The system of claim 15, wherein the one or more areas include a top portion of a home or a tree.

17. The system of claim 15, wherein the one or more clips include at least one v-shaped clip.

18. The system of claim 15, wherein the one or more clips are positioned in one or more areas of a tree.

19. The system of claim 15, wherein the one or more decorations or attachments include at least one tree accessory.

20. The system of claim 15, further comprising:
releasing the one or more decorations or attachments from the clip.
